(19) United States
(12) Patent Application Publication
(10) Pub. No.: US 2013/0048137 A1
(43) Pub. Date: Feb. 28, 2013

(54) PROCESS FOR PRODUCING INSULATED PIPES HAVING IMPROVED PROPERTIES

(71) Applicants: Christof GRIESER-SCHMITZ, Osnabrueck (DE); Gianpaolo Tomasi, Diepholz (DE); Ludwig Windeler, Marl (DE); Alex Popov, Lemfoerde (DE); Carsten Ellersiek, Lengerich (DE); Annika Halwe-Bommelmann, Rahden-Varl (DE)

(72) Inventors: Christof GRIESER-SCHMITZ, Osnabrueck (DE); Gianpaolo Tomasi, Diepholz (DE); Ludwig Windeler, Marl (DE); Alex Popov, Lemfoerde (DE); Carsten Ellersiek, Lengerich (DE); Annika Halwe-Bommelmann, Rahden-Varl (DE)

(73) Assignee: BASF SE, Ludwigshafen (DE)

(21) Appl. No.: 13/597,548

(22) Filed: Aug. 29, 2012

Related U.S. Application Data
(60) Provisional application No. 61/529,257, filed on Aug. 31, 2011.

(51) Int. Cl. B29C 44/24; F16L 9/14

(52) U.S. Cl. 138/149; 264/46.5

(57) ABSTRACT

The present invention relates to a process for producing insulated pipes, the use of a polyurethane system comprising an isocyanate component (a), a polyol mixture (b) and at least one catalyst for producing insulated pipes, wherein the cream time for the polyurethane system is less than the time for introduction of the polyurethane system into the pipe, the use of specific amines as catalyst in a polyurethane system for producing insulated pipes and also an insulated pipe which can be obtained by the process of the invention.

The present invention relates to a process for producing insulated pipes, which comprises the steps (A) provision of a pipe for a medium and a sheathing pipe, where the pipe for a medium is arranged within the sheathing pipe and an annular gap is formed between the pipe for a medium and the sheathing pipe, (B) introduction of a polyurethane system comprising at least one isocyanate component (a), at least one polyol mixture (b) and at least one catalyst into the annular gap and (C) foaming the polyurethane system and allowing it to cure, where the cream time for the polyurethane system is less than or equal to the introduction time, the use of a polyurethane system comprising an isocyanate component (a), a polyol mixture (b) and at least one catalyst for producing insulated pipes, where the cream time of the polyurethane system is less than the time for introduction of the polyurethane system into the pipe, the use of specific amines as catalyst in a polyurethane system for producing insulated pipes and also an insulated pipe which can be obtained by the process of the invention.

Pipes insulated with polyurethane foams are known in the prior art and are described, for example, in EP-A-865 893 and DE-A-197 42 012. Insulated pipe systems are made up from individual pipe segments. Pipe lengths of 6 m, 12 m and 16 m are normally used for this purpose. Overhang lengths required are specially manufactured or cut to size from existing standard product. The individual pipe segments are welded together and provided with additional insulation in the region of the weld by means of existing muff technology. These muff connections incur a greater damage potential than the pipe product itself. This difference results from the fact that the pipe lengths are produced under set, controllable conditions in production buildings. The muff connections are often produced under time pressure in situ on the building sites in wind and weather. Influences such as temperature, soiling and moisture often influence the quality of the muff connections. Furthermore, the number of muff connections is a large cost factor in the installation of pipe systems.

It is therefore desirable in the pipe processing industry to install as few as possible muff connections, based on the length of a line. This is achieved by the use of longer single pipe segments, but the production of these is more demanding and frequently leads to technical problems.

The major part of individual pipes is produced by means of batchwise pipe-in-pipe production. In this process, the pipe for a medium, generally a steel pipe, is provided with star-shaped spacers which serve to center the inner pipe. The pipe for a medium is pushed into the outer sheathing pipe, generally made of polyethylene, so as to give an annular gap between the two pipes. This annular gap is filled with polyurethane foam because of the excellent insulating properties of the latter. For this purpose, the gently inclined double pipe is provided with closure caps which are equipped with venting holes. The liquid reaction mixture is subsequently introduced into the annular gap by means of a polyurethane metering machine and flows downward in still liquid form in the annular gap until the reaction commences. From this point in time onwards, the further distribution occurs by flow of the foam which is slowly increasing in viscosity until the material has fully reacted.

EP 1 552 915 A2 discloses a process for producing insulated pipes, in which a polyurethane system comprising an isocyanate component and a polyol component having a low viscosity of less than 3000 mPas is introduced into an appropriate pipe comprising a pipe for a medium and a sheathing pipe. After introduction, the polyurethane system foams and cures at the same time. Amines such as triethylamine or 1,4-diazabicyclo[2.2.2]octane are used as catalysts for polyurethane formation.

EP 1 783 152 A2 likewise discloses a process for producing insulated pipes, in which a polyurethane system comprising an isocyanate component and a polyol component having a particularly low viscosity of less than 1300 mPas is introduced into a pipe comprising a pipe for a medium and a sheathing pipe. This document, too, names amines such as triethylamine or 1,4-diazabicyclo[2.2.2]octane as suitable catalysts.

Accordingly, the documents EP 1 552 915 A2 and EP 1 783 152 A2 describe processes for producing insulated pipes, in which the problem of complete filling of the pipe before foaming and curing is solved by using polyol components having a particularly low viscosity and thus a good flowability.

In order to manufacture, in particular, economically desirable, relatively long preinsulated pipes, the reacting polyurethane foam generally has to be given a very slow reaction profile. This is based on the fact that the foam in the liquid (not yet reacting) state has to achieve a good predistribution in the pipe. Furthermore, in the case of large pipe dimensions, sufficient time has to be available for the required polyurethane material to be introduced into the annular gap within the cream time. Both require a long cream time. However, long cream times lead to greater cell diameters which, since the radius of the cell goes into the calculation as the square, lead to a significantly increasing thermal conductivity. However, a minimum thermal conductivity of the foam and thus a maximum energy saving is desired for economic and ecological reasons.

In addition, a slow reaction profile of the polyurethane foam leads to a correspondingly greater time requirement in the production of the pipe lengths. To increase the productivity and, associated therewith, reduce the production costs, an acceleration of the reaction profile is likewise desirable.

Furthermore, a uniform foam density distribution of the foam is important for the quality of the pipes. However, this is not advantageous when the polyurethane systems known from the prior art are used. A lower foam density is usually obtained at the ends of the pipe and a higher foam density is obtained in the middle. The longer the pipe, the greater, due to process engineering reasons, the required overall foam density of the foam in the gap in the pipe.

Owing to a limited commercially available maximum discharge performance for the polyurethane reaction mixture, the maximum thickness of the insulation layer is limited for a simultaneously desirable large pipe length. The possibility of being able to introduce the reaction mixture into the annular gap beyond the cream time leads to greater insulation layer thicknesses being able to be realized industrially. These are desirable in order to minimize the heat loss from the insulated pipe.

It was an object of the invention to provide a process for producing insulated pipes, which process gives pipes which have a low overall foam density and small cell diameters of the polyurethane foam obtained and thus have a low thermal conductivity. Likewise, a fast process by means of which high-quality insulated pipes can be produced in a short time should be provided. Furthermore, thicker insulation layers should be possible.

These objects are achieved according to the invention by a process for producing insulated pipes, which comprises the steps:
(A) provision of a pipe for a medium and a sheathing pipe, where the pipe for a medium is arranged within the sheathing pipe and an annular gap is formed between the pipe for a medium and the sheathing pipe,
(B) introduction of a polyurethane system comprising at least one isocyanate component (a), at least one polyol mixture (b) and at least one catalyst into the annular gap and
(C) foaming the polyurethane system and allowing it to cure,
   wherein the cream time for the polyurethane system is less than or equal to the introduction time.

According to the invention, the cream time of the polyurethane system is the time from the combining of the components required for the reaction, i.e. isocyanate component (a), polyol component (b) and at least one catalyst, which elapses at the suitable reaction temperature until an appreciable commencement of the polymerization reaction is observed. The commencement of the polymerization reaction can, for example, be determined by means of an increase in the viscosity of the reaction mixture or commencement of an increase in volume of the liquid reaction mixture.

According to the invention, the introduction time as per step (B) is the time required to introduce 100% of the required reaction mixture into the annular gap.

According to the invention, the cream time of the polyurethane system is less than or equal to the introduction time, preferably at least 5% less, particularly preferably at least 10% less, very particularly preferably at least 15% less, in particular at least 20% less than the introduction time.

The amount of polyurethane system to be introduced is determined as a function of type, composition, desired degree of fill, expansion behavior, pipe dimensions, etc.

The process of the invention is generally a batch process.

The individual steps of the process of the invention are described in detail below:

Step (A):

Step (A) of the process of the invention comprises provision of a pipe for a medium and a sheathing pipe, where the pipe for a medium is arranged within the sheathing pipe and an annular gap is formed between the pipe for a medium and the sheathing pipe.

The pipe for a medium, which has a smaller diameter than the sheathing pipe, is arranged within the sheathing pipe so as to form an annular gap between the pipe for a medium and the sheathing pipe. The polyurethane system is introduced into this annular gap in step (B) according to the invention.

The pipe for a medium used according to the invention is generally a steel pipe having an external diameter of, for example, from 1 to 120 cm, preferably from 4 to 110 cm. The length of the pipe for a medium is, for example, from 1 to 24 meters, preferably from 6 to 16 meters. In a preferred embodiment of the process of the invention, a folded spiral-seam tube is used as sheathing pipe.

The sheathing pipe used according to the invention can in general comprise any material which appears suitable to a person skilled in the art, for example a material based on a thermoplastic polymer, preferably polyethylene.

The present invention therefore preferably provides the process of the invention in which a pipe based on thermoplastic polymer is used as sheathing pipe.

The sheathing pipe generally has a thickness of from 1 to 30 mm. The internal diameter of the sheathing pipe is generally from 6 to 140 cm, preferably from 10 to 120 cm. The length of the sheathing pipe is, for example, from 1 to 24 meters, preferably from 6 to 16 meters.

The sheathing pipe can optionally comprise a plurality of layers which can be brought together in the extrusion process for producing the sheathing pipe. An example of this is the introduction of multilayer films between polyurethane foam and sheathing pipe, with the film containing at least one metal layer to improve the barrier action. Suitable sheathing pipes of this type are described in EP-A-960 723.

In a particularly preferred embodiment, the insulated pipe produced according to the invention is an insulated composite sheathing pipe for district heating networks laid in the ground which meets the requirements of DIN EN 253:2009.

The double pipe made up of pipe for a medium and sheathing pipe is, according to the invention, preferably provided on an inclinable foaming table, so that it can be inclined at an angle of from 0° to 10°, preferably from 0° to 7°. The ends of the double pipe are preferably provided with closure caps which are equipped with venting holes.

According to the invention, the introduction of the polyurethane system can take place at one end of the pipe or in the middle or at any other point between one end and the middle, in each case into the annular gap present there between pipe for a medium and sheathing pipe.

The present invention therefore preferably provides the process of the invention in which the introduction of the polyurethane system in step (B) is effected at one end of the pipe or in the middle of the pipe or at any point between one end and the middle of the pipe.

In a preferred embodiment of the process of the invention, the polyurethane system is, in step (B), introduced into the middle of the double pipe made up of pipe for a medium and sheathing pipe as provided in step (A). The double pipe is therefore aligned appropriately, for example horizontally, in step (A).

According to the invention, the middle of the pipe is a region which is located at about 35-70%, preferably 40-60%, particularly preferably 45-55%, of the length of the sheathing pipe.

In step (A) of the process of the invention, all further devices, for example for introducing the polyurethane system, for venting the annular gap, for heating/cooling, etc., are attached to the double pipe made up of sheathing pipe and pipe for a medium.

Step (B):

Step (B) of the process of the invention comprises introduction of a polyurethane system comprising at least one isocyanate component (a), at least one polyol mixture (b) and at least one catalyst into the annular gap.

The introduction of the polyurethane system in step (B) into the annular gap between pipe for a medium and sheathing pipe is effected, for example, by means of a polyurethane metering machine known to those skilled in the art.

The liquid reaction mixture, i.e. the polyurethane system according to the invention, flows downward in still liquid form into the annular gap during and after introduction until the polymerization reaction with foam formation commences. From this point in time onwards, the further distribution takes place by flow of the foam which has a slowly increasing viscosity until the material has fully reacted.

The polyurethane system used in step (B) of the process of the invention is described in detail below.

As isocyanate component (a), use is made of the customary aliphatic, cycloaliphatic and in particular aromatic diisocyanates and/or polyisocyanates. Preference is given to using tolylene diisocyanate (TDI), diphenylmethane diisocyanate (MDI) and in particular mixtures of diphenylmethane diisocyanate and polyphenylene polymethylene polyisocyanates (crude MDI). The isocyanates can also be modified, for example by incorporation of uretdione, carbamate, isocyanurate, carbodiimide, allophanate and in particular urethane groups.

The isocyanate component (a) can also be used in the form of polyisocyanate prepolymers. These prepolymers are known from the prior art. They are prepared in a manner known per se by reacting polyisocyanates (a) as described above, for example at temperatures of about 80° C., with compounds having hydrogen atoms which are reactive toward isocyanates, preferably with polyols, to form polyisocyanate prepolymers. The polyol:polyisocyanate ratio is generally selected so that the NCO content of the prepolymer is from 8 to 25% by weight, preferably from 10 to 22% by weight, particularly preferably from 13 to 20% by weight.

According to the invention, particular preference is given to using crude MDI as isocyanate component.

In a preferred embodiment, the isocyanate component (a) is selected so that it has a viscosity of less than 800 mPas, preferably from 100 to 650 mPas, particularly preferably from 120 to 400 mPas, in particular from 180 to 350 mPas, measured in accordance with DIN 53019 at 20° C.

For the purposes of the present invention, the polyurethane systems and polyurethane foams according to the invention are preferably essentially free of isocyanate groups. The ratio of isocyanurate group to urethane group in the foam is preferably less than 1:10, particularly preferably less than 1:100. In particular, essentially no isocyanurate groups are present in the polyurethane foam used according to the invention.

In the polyurethane system used according to the invention, the polyol mixture (b) generally comprises polyols as constituent (b1) and optionally chemical blowing agents as constituent (b2). In general, the polyol mixture (b) comprises physical blowing agents (b6).

The viscosity of the polyol mixture (b) used according to the invention (but without physical blowing agents (b6)) is generally from 200 to 10 000 mPas, preferably from 500 to 9500 mPas, particularly preferably from 1000 to 9000 mPas, very particularly preferably from 2500 to 8500 mPas, in particular from 3100 to 8000 mPas, in each case measured at 20° C. in accordance with DIN 53019. In a particularly preferred embodiment, a polyol mixture (b) (but without physical blowing agents (b6)) having a viscosity of more than 3000 mPas, for example from 3100 to 8000 mPas, in each case measured in accordance with DIN 53019 at 20° C. is used in the process of the invention.

The present invention therefore preferably provides the process of the invention in which a polyol mixture (b) (but without physical blowing agents (b6)) having a viscosity of more than 3000 mPas, for example from 3100 to 8000 mPas, in each case measured in accordance with DIN 53019 at 20° C. is used.

The polyol mixture (b) generally comprises physical blowing agents (b6). However, the addition of physical blowing agents leads to a significant decrease in the viscosity. It is therefore an important aspect of the invention that the abovementioned viscosity values for the polyol mixture (b) relate, even in the case of the mixture comprising physical blowing agents, to the viscosity of the polyol mixture (b) without addition of physical blowing agents (b6).

Possible polyols (constituent b1) are in general compounds having at least two groups which are reactive toward isocyanate, i.e. has at least two hydrogen atoms which are reactive toward isocyanate groups. Examples are compounds having OH groups, SH groups, NH groups and/or NH₂ groups.

As polyols (constituent b1), preference is given to using compounds based on polyesterols or polyetherols. The functionality of the polyetherols and/or polyesterols is generally from 1.9 to 8, preferably from 2.4 to 7, particularly preferably from 2.9 to 6.

The polyols (b1) have a hydroxyl number of generally greater than 100 mg KOH/g, preferably greater than 150 mg KOH/g, particularly preferably greater than 200 mg KOH/g. As upper limit to the hydroxyl number, a value of 1000 mg KOH/g, preferably 800 mg KOH/g, particularly preferably 700 mg KOH/g, very particularly preferably 600 KOH/g, has generally been found to be appropriate. The abovementioned OH numbers relate to the totality of the polyols (b1), which does not rule out individual constituents of the mixture having higher or lower values.

Component (b1) preferably comprises polyether polyols prepared by known methods, for example from one or more alkylene oxides having from 2 to 4 carbon atoms in the alkylene radical by anionic polymerization using alkali metal hydroxides such as sodium or potassium hydroxide or alkali metal alkoxides such as sodium methoxide, sodium or potassium methoxide or potassium isopropoxide as catalysts with addition of at least one starter molecule comprising from 2 to 8, preferably from 3 to 8, reactive hydrogen atoms in bound form or by cationic polymerization using Lewis acids such as antimony pentachloride, boron fluoride etherate, etc., or bleaching earth as catalysts.

Suitable alkylene oxides are, for example, tetrahydrofuran, 1,3-propylene oxide, 1,2- or 2,3-butylene oxide, styrene oxide and preferably ethylene oxide and 1,2-propylene oxide. The alkylene oxides can be used individually, alternately in succession or as mixtures.

Possible starter molecules are alcohols such as glycerol, trimethylolpropane (TMP), pentaerythritol, sucrose, sorbitol, and amines such as methylamine, ethylamine, isopropylamine, butylamine, benzylamine, aniline, toluidine, toluenediamine, naphthylamine, ethylenediamine (EDA), diethylenetriamine, 4,4′-methylenedianiline, 1,3-propanediamine, 1,6-hexanediamine, ethanolamine, diethanolamine, triethanolamine and the like.

Further possible starter molecules are condensation products of formaldehyde, phenol and diethanolamine or ethanolamine, formaldehyde, alkylphenols and diethanolamine or ethanolamine, formaldehyde, bisphenol A and diethanolamine or ethanolamine, formaldehyde, aniline and diethanolamine or ethanolamine, formaldehyde, cresol and diethanolamine or ethanolamine, formaldehyde, toluidine and diethanolamine or ethanolamine and also formaldehyde, toluenediamine (TDA) and diethanolamine or ethanolamine and the like.

Preference is given to using glycerol, sucrose, sorbitol and EDA as starter molecules.

Furthermore, the polyol mixture can optionally comprise chemical blowing agents as constituent (b2). As chemical blowing agents, preference is given to water or carboxylic acids, in particular formic acid. The chemical blowing agent is generally used in an amount of from 0.1 to 5% by weight, in particular from 1.0 to 3.0% by weight, based on the weight of the component (b).

As mentioned above, the polyol mixture (b) generally comprises a physical blowing agent (b6). Physical blowing agents are compounds which are dissolved or emulsified in the starting materials for polyurethane production and vaporize under the conditions of polyurethane formation. Examples are hydrocarbons, for example cyclopentane, halogenated hydrocarbons and other compounds, for example perfluorinated alkanes such as perfluorohexane, chlorofluorocarbons, and also ethers, esters, ketones and/or acetals. These are usually used in an amount of from 1 to 30% by weight, preferably from 2 to 25% by weight, particularly preferably from 3 to 20% by weight, based on the total weight of the components (b).

The present invention therefore preferably provides the process of the invention in which the polyurethane system is foamed using cyclopentane as physical blowing agent.

In a preferred embodiment, the polyol mixture (b) comprises crosslinkers as constituent (b3). For the purposes of the present invention, crosslinkers are compounds which have a molecular weight of from 60 to less than 400 g/mol and have at least 3 hydrogen atoms which are reactive toward isocyanates. An example is glycerol.

The crosslinkers (b3) are generally used in an amount of from 1 to 10% by weight, preferably from 2 to 6% by weight, based on the total weight of the polyol mixture (b) (but without physical blowing agents (b6)).

In a further preferred embodiment, the polyol mixture (b) comprises chain extenders which serve to increase the crosslinking density as constituent (b4). For the purposes of the present invention, chain extenders are compounds which have a molecular weight of from 60 to less than 400 g/mol and have 2 hydrogen atoms which are reactive toward isocyanates. Examples of are butanediol, diethylene glycol, dipropylene glycol and ethylene glycol.

The chain extenders (b4) are generally used in an amount of from 2 to 20% by weight, preferably from 4 to 15% by weight, based on the total weight of the polyol mixture (b) (but without physical blowing agents).

The components (b3) and (b4) can be used individually or in combination in the polyol mixture.

The polyurethane foams present as insulation material according to the invention can be obtained by reaction of the polyurethane systems according to the invention.

In the reaction, the polyisocyanates (a) and the polyol mixture (b) are generally reacted in such amounts that the isocyanate index of the foam is from 90 to 240, preferably from 90 to 200, particularly preferably from 95 to 180, very particularly preferably from 95 to 160, in particular from 100 to 149.

In a preferred embodiment, the components (a) and (b) of the polyurethane system are selected so that the resulting foam has a compressive strength (at a foam density of 60 kg/m³) of greater than 0.2 N/mm², preferably greater than 0.25 N/mm², particularly preferably greater than 0.3 N/mm², measured in accordance with DIN 53421.

In general, the overall shot foam density in the process of the invention is less than 80 kg/m³, preferably less than 75 kg/m³, particularly preferably less than 70 kg/m³, very particularly preferably less than 65 kg/m³, in particular less than 60 kg/m³. The overall shot foam density is generally understood to be the total amount of liquid polyurethane material introduced divided by the total volume of the annular gap filled with foam.

The process of the invention can be carried out at any compaction which appears to be suitable to a person skilled in the art. For the purposes of the present invention, the compaction is the ratio obtained from the total fill density of the tubular gap divided by the free-foamed core density determined on an uncompacted foam body.

The present invention preferably provides the process of the invention in which the reaction is carried out as a compaction of less than 4.0, preferably less than 3.5, particularly preferably less than 3.0 and very particularly preferably less than 2.5.

The polyurethane system used in step (B) of the process of the invention further comprises at least one catalyst. According to the invention, use is made of at least one catalyst which makes it possible for the cream time for the polyurethane system to be less than the time for introduction in step (B). As a result of the cream time for the polyurethane system being, according to the invention, less than the time for filling in step (B), the invention surprisingly provides a process in which the advantages of, firstly, the annular gap of the pipe produced according to the invention being able to be filled uniformly and completely with polyurethane foam and, secondly, a foam which, owing to the rapid cream time, has small cells and thus a particularly low thermal conductivity being obtained are combined.

Catalysts which are preferably used according to the invention catalyze the blowing reaction, i.e. the reaction of diisocyanate with water. This reaction takes place predominantly before the actual polyurethane chain formation, i.e. the polymerization reaction, and therefore leads to a fast reaction profile of the polyurethane system.

In the process of the invention, the at least one catalyst is preferably an amine of the general formula (I)

R¹R²N(CR³R⁴)ₙ—X (I),

where R¹, R², R³, R⁴, n and X have the following meanings:

R¹, R² are each, independently of one another, a C1-C₈-alkyl radical,

R³, R⁴ are each, independently of one another, hydrogen or a C₁-C₈-alkyl radical,

n is an integer from 1 to 6 and

X is OR⁵ or NR⁶R⁷ where
R⁵ is a C₁-C₈-alkyl radical or C₁-C₈-heteroalkyl radical,
R⁶ is, independently of one another, hydrogen or a C₁-C₈-alkyl radical,
R⁷ is a C₁-C₈-alkyl radical or C₁-C₈-heteroalkyl radical.

The present invention therefore preferably provides the process of the invention in which the at least one catalyst is an amine of the general formula (I)

R¹R²N(CR³R⁴)ₙ—X (I),

where R¹, R², R³, R⁴, n and X have the following meanings:

R¹, R² are each, independently of one another, a C₁-C₈-alkyl radical,

R³, R⁴ are each, independently of one another, hydrogen or a C₁-C₈-alkyl radical,

n is an integer from 1 to 6 and

X is OR⁵ or NR⁶R⁷ where
R⁵ is a C₁-C₈-alkyl radical or C₁-C₈-heteroalkyl radical,
R⁶ is, independently of one another, hydrogen or a C₁-C₈-alkyl radical,
R⁷ is a C₁-C₈-alkyl radical or C₁-C₈-heteroalkyl radical.

The preferences and preferred embodiments of R¹, R², R³, R⁴, R⁵, R⁶ and R⁷ and of X and n are indicated below:

R¹ and R² are each, independently of one another, a C₁-C₈-alkyl radical, preferably a C₁-C₄-alkyl radical. Such radicals can, according to the invention, be linear or branched, preferably linear. Examples of particularly preferred radicals for R¹ and R² are methyl, ethyl, propyl, for example n-propyl or isopropyl, butyl, for example n-butyl or isobutyl. In a preferred embodiment, R¹ and R² are identical; R¹ and R² are very particularly preferably each methyl.

R³ and R⁴ are each, independently of one another, hydrogen or a C₁-C₈-alkyl radical, preferably hydrogen or a C₁-C₄-alkyl radical. Such radicals can, according to the invention, be linear or branched, preferably linear. Examples of preferred radicals for R³ and R⁴ are methyl, ethyl, propyl, for example n-propyl or isopropyl, butyl, for example n-butyl or isobutyl. In a preferred embodiment, R³ and R⁴ are identical; R³ and R⁴ are very particularly preferably each hydrogen.

In the general formula (I), n indicates the number of —CR³R⁴— groups present. n is generally an integer from 1 to 6, for example 1, 2, 3, 4, 5 or 6, particularly preferably 2.

In a first embodiment, X in the general formula (I) is OR⁵ where R⁵ is a C₁-C₈-alkyl radical, preferably a C₁-C₄-alkyl radical, or a C₁-C₈-heteroalkyl radical.

C₁-C₈-Alkyl radicals suitable for R⁵, preferably C₁-C₄-alkyl radicals, can, according to the invention, be linear or branched, preferably linear. Examples of preferred radicals for R⁵ are methyl, ethyl, propyl, for example n-propyl or isopropyl, butyl, for example n-butyl or isobutyl.

In a preferred embodiment, X is OR⁵ where R⁵ is a C₁-C₈-heteroalkyl radical, preferably a C₁-C₅-heteroalkyl radical. In the C₁-C₅-heteroalkyl radicals which are preferred according to the invention, from 1 to 3 heteroatoms are present in addition to the carbon atoms.

Heteroatoms which are suitable for the purposes of the invention are N, O, P, S, preferably N and O. Heteroalkyl radicals present according to the invention can be linear or branched.

Particularly preferred groups R⁵ are —CH₂—CH₂—N(CH₃)₂ or —CH₂—CH₂—OH.

In a second embodiment, X in the general formula (I) is NR⁶R⁷ where the radicals R⁶ are each, independently of one another, hydrogen, a C₁-C₈-alkyl radical, preferably a C₁-C₄-alkyl radical, or a C₁-C₈-heteroalkyl radical, and the radicals R⁷ are each, independently of one another, a C₁-C₈-alkyl radical, preferably a C₁-C₄-alkyl radical, or a C₁-C₈-heteroalkyl radical.

R⁶ is preferably hydrogen or a C₁-C₄-alkyl radical. Such radicals can, according to the invention, be linear or branched, preferably linear. Examples of preferred radicals for R⁶ are hydrogen, methyl, ethyl, propyl, for example n-propyl or isopropyl, butyl, for example n-butyl or isobutyl. In a particularly preferred embodiment, R⁶ is methyl or ethyl.

R⁷ is preferably a C₁-C₈-heteroalkyl radical, preferably a C₁-C₅-heteroalkyl radical. In the C₁-C₅-heteroalkyl radicals which are preferred according to the invention, from 1 to 3 heteroatoms are present in addition to the carbon atoms.

Particularly preferred groups R⁷ are —CH₂—CH₂—N(CH₃)₂ or —CH₂—CH₂—OH.

Thus, X in the general formula (I) is preferably —O—CH₂—CH₂—N(CH₃)₂, —O—CH₂—CH₂—OH, —N(CH₃)CH₂—CH₂—N(CH₃)₂ or —N(CH₃)CH₂—CH₂—OH.

Catalysts which are very particularly preferably used according to the invention are therefore selected from the group consisting of N,N,N,N,N-pentamethyldiethylenetriamine (Ia), bis(dimethylaminoethyl)ether (Ib), N,N-dimethylaminoethyl-N-methylethanolamine (Ic), N,N-dimethylaminoethoxyethanol (Id) and mixtures thereof. The abovementioned particularly preferred catalysts are depicted below:

(CH₃)₂N—CH₂—CH₂N(CH₃)CH₂—CH₂—N(CH₃)₂ (Ia)

(CH₃)₂N—CH₂—CH₂—O—CH₂—CH₂—N(CH₃)₂ (Ib)

(CH₃)₂N—CH₂—CH₂N(CH₃)CH₂—CH₂—OH (Ic)

(CH₃)₂N—CH₂—CH₂—O—CH₂—CH₂—OH (Id)

The present invention therefore preferably provides the process of the invention in which the at least one catalyst is selected from the group consisting of N,N,N,N,N-pentamethyldiethylenetriamine (Ia), bis(dimethylaminoethyl)ether (Ib), N,N-dimethylaminoethyl-N-methylethanolamine (Ic), N,N-dimethylaminoethoxyethanol (Id) and mixtures thereof.

The catalysts which are preferred according to the invention can be added to the polyurethane system in any way known to those skilled in the art, for example as such or as a solution, for example as an aqueous solution.

According to the invention, the at least one catalyst is added in an amount, based on the polyol component (b), of from 0.01 to 1.5% by weight, preferably from 0.05 to 1.0% by weight, particularly preferably from 0.05 to 0.5% by weight, very particularly preferably from 0.1 to 0.3% by weight.

Additives (b5) can optionally also be added to the polyurethane system used according to the invention. For the purposes of the present invention, additives (b5) are the customary auxiliaries and additives known in the prior art, but not physical blowing agents. Mention may be made by way of example of surface-active substances, foam stabilizers, cell regulators, fillers, dyes, pigments, flame retardants, antistatics, hydrolysis inhibitors and/or fungistatic and bacteriostatic substances. It may be remarked that the abovementioned general and preferred viscosity ranges for component (b) also apply to a polyol mixture (b) including any additives (b5) added (but excluding any physical blowing agents (b6) added).

The present invention therefore preferably provides the process of the invention in which the at least one polyol mixture (b) comprises polyols (b1), optionally chemical blowing agents (b2), crosslinkers (b3), chain extenders (b4), additives (b5) and/or physical blowing agents (b6).

The present invention therefore provides, in particular, the process of the invention in which from 1 to 25% by weight of flame retardants, based on the total weight of the polyol mixture, are added as additive (b5).

Step (C):

Step (C) of the process of the invention comprises foaming the polyurethane system and allowing it to cure.

After introduction of the polyurethane system into the annular gap, the polymerization reaction to form the polyurethane foam commences. Since, according to the invention, the cream time for the polyurethane system is less than the time for the introduction in step (B), this reaction commences while further polyurethane system is being introduced. This gives the abovementioned advantages according to the invention.

The foaming and curing is, according to the invention, generally carried out at a component temperature of from 18 to 35° C., preferably from 20 to 30° C., particularly preferably from 22 to 28° C.

The foaming and curing is, according to the invention, generally carried out at surface temperatures of from 15 to 50° C., preferably from 20 to 50° C., particularly preferably from 25 to 45° C.

After step (C) of the process of the invention, an insulated pipe comprising at least a pipe for a medium, a sheathing pipe and an insulating layer of polyurethane foam between pipe for a medium and sheathing pipe is obtained.

The insulating layer generally has a thickness of from 1 to 20 cm, preferably from 5 to 20 cm, particularly preferably from 7 to 20 cm.

In a further preferred embodiment, the insulating layer comprising polyurethane foam has a thermal conductivity of less than 27 mW/mK, preferably from 22 to 26.7 mW/mK, measured in accordance with EN ISO 8497.

The present invention also provides for the use of a polyurethane system comprising an isocyanate component (a), a polyol mixture (b) and at least one catalyst for producing insulated pipes, wherein the cream time for the polyurethane system is less than the time for introduction of the polyurethane system into the pipe.

In particular, the present invention provides for the use according to the invention in which an amine of the general formula (I)

R¹R²N(CR³R⁴)ₙ—X (I),

where R¹, R², R³, R⁴, n and X have the following meanings:

R¹, R² are each, independently of one another, a C₁-C₈-alkyl radical,

R³, R⁴ are each, independently of one another, hydrogen or a C₁-C₈-alkyl radical,

n is an integer from 1 to 6 and

X is OR⁵ or NR⁶R⁷ where
R⁵ is a C₁-C₈-alkyl radical or C₁-C₈-heteroalkyl radical,
R⁶ is, independently of one another, hydrogen or a C₁-C₈-alkyl radical,
R⁷ is a C₁-C₈-alkyl radical or C₁-C₈-heteroalkyl radical,
   is used as catalyst.

The present invention also provides for the use of an amine of the general formula (I)

R¹R²N(CR³R⁴)ₙ—X (I),

where R¹, R², R³, R⁴, n and X have the following meanings:

R¹, R² are each, independently of one another, a C₁-C₈-alkyl radical,

R³, R⁴ are each, independently of one another, hydrogen or a C₁-C₈-alkyl radical,

n is an integer from 1 to 6 and

X is OR⁵ or NR⁶R⁷ where
R⁵ is a C₁-C₈-alkyl radical or C₁-C₈-heteroalkyl radical,
R⁶ is, hydrogen or a C₁-C₈-alkyl radical,
R⁷ is a C₁-C₈-alkyl radical or C₁-C₈-heteroalkyl radical,
   as catalyst in a polyurethane system for producing insulated pipes.

The individual features of these further subjects of the present invention and the preferred embodiments correspond to what has been said with regard to the process of the invention.

The present invention also provides an insulated pipe which can obtained by the process of the invention.

The individual features of the insulated pipe of the present invention and the preferred embodiments correspond to what has been said with regard to the process of the invention.

Examples of insulated pipes according to the invention are district heating pipes or composite jacket pipes in accordance with DIN EN 253:2009.

The insulated pipe of the invention is generally made up of (i) a pipe for a medium, (ii) a layer of polyurethane foam and (iii) a sheathing pipe.

The process of the invention for producing insulated pipes has the following advantages:

1. Simplified production of relatively long pipe segments

2. Reduced overall foam density

3. Better foam density distribution

4. Lower thermal conductivity

5. Increased productivity due to shorter curing times

6. Cost savings by use of PUR metering machines having a low output

7. Increase in the maximum thickness of the insulation layer

Examples:

The following examples 1 (according to the invention) and also 2.1 and 2.2 (each comparative examples) are carried out. The components used and the properties of the reaction mixtures and of the foams obtained are shown in tables 1 and 2 below. The foam was in each case processed on a high-pressure PUR metering machine HK 2500 from Hennecke, St Augustin. A pipe having a middle inlet and the following dimensions: diameter of steel pipe 250 mm, diameter of PE outer sheathing pipe 450 mm, length filled with foam: 15.6 m, was in each case filled.

A comparison is made of the production according to the invention of such a pipe (example 1) with a standard foam processed in the same way (comparison, example 2.1) and with the standard foam processed in the standard way (comparison, example 2.2). In example 2.1, it was observed that the pipe did not become full. In example 2.2, it was observed that the pipe became full but a foam having poorer properties was obtained.

TABLE 1

| | Example | | |
|---|---|---|---|
| | 1 | 2.1 | 2.2 |
| Polyol A | 30 | 30 | 30 |
| Polyol B | 20 | 20 | 20 |
| Polyol C | 40 | 40 | 40 |
| Polyol D | 5 | 5 | 5 |
| Glycerol | 2 | 2 | 2 |
| Tegostab B 8462 ® | 1.5 | 1.5 | 1.5 |
| (Goldschmidt AG Essen) | | | |
| Catalyst DMCHA | 0.5 | 0.8 | 0.8 |
| Catalyst | 0.2 | — | — |
| N,N,N,N,N-pentamethyldiethylene- | | | |
| triamine | | | |
| Water | 2.0 | 2.0 | 2.0 |
| Cyclopentane | 13 | 13 | 13 |
| Total | 84.2 | 84.3 | 84.3 |
| Pentane | 13.0 | 13.0 | 13.0 |
| Lupranat M 20S | 164 | 164 | 164 |
| Isocyanate index | 130 | 130 | 130 |
| Cream time [s] | 15 | 24 | 24 |
| Fiber time [s] | 82 | 118 | 118 |
| Free foam density [kg/m³] | 32 | 34 | 34 |
| Lambda value | 25.4 | — | 26.8 |
| (EN ISO 8497 - 50° C.) [mW/m*K] | | | |
| Introduction time [s] | 21 | 21 | 29 |
| Overall foam density [kg/m³] | 62 | 62 | 83 |
| Time to exit from end of pipe [s] | 62/68 | — | 120/136 |
| Average cell diameter [μm] | 190 | — | 260 |
| Foam appearance | No | — | Some |
| | streaking | | streaking |
| Sliding zone at the ends | None | — | about 1.5 m |
| | | | at each end |

Unless indicated otherwise, all parts are by weight. The average cell diameter is determined in accordance with EN 489:2009 (section 5.4.5.1).

In table 1, the following items have the functions indicated:

| | |
|---|---|
| Tegostab B 8462 ® | cell stabilizer |
| DMCHA | gel catalyst |
| Lupranat M 20S | diisocyanate |

TABLE 2
Properties of the polyols used

| | OH | | Viscos- | Molecular | Basic |
|---|---|---|---|---|---|
| | number | Function- | ity | weight | chemical |
| | [mg KOH/g] | ality | [25° C.] | [g/mol] | framework |
| Polyol A | 400 | 3 | 370 | 420 | Glycerol-PO |
| Polyol B | 490 | 4.9 | 23000 | 560 | Sorbitol-PO |
| Polyol C | 490 | 4.3 | 8300 | 500 | Sucrose- |
| | | | | | glycerol-PO |
| Polyol D | 470 | 3.9 | 5000 | 470 | EDA-PO |

1. A process for producing insulated pipes, which comprises the steps:
(A) provision of a pipe for a medium and a sheathing pipe, wherein the pipe for a medium is arranged within the sheathing pipe and an annular gap is formed between the pipe for a medium and the sheathing pipe,
(B) introduction of a polyurethane system comprising at least one isocyanate component (a), at least one polyol mixture (b) and at least one catalyst into the annular gap and
(C) foaming the polyurethane system and allowing it to cure,
wherein the cream time for the polyurethane system is less than or equal to the introduction time.

2. The process according to claim 1, wherein the at least one catalyst is an amine of the general formula (I)
R¹R²N(CR³R⁴)ₙ—X (I),
where R¹, R², R³, R⁴, n and X have the following meanings:
R¹, R² are each, independently of one another, a C₁-C₈-alkyl radical,
R³, R⁴ are each, independently of one another, hydrogen or a C₁-C₈-alkyl radical,
n is an integer from 1 to 6 and
X is OR⁵ or NR⁶R⁷ where
R⁵ is a C₁-C₈-alkyl radical or C₁-C₈-heteroalkyl radical,
R⁶ is, independently of one another, hydrogen or a C₁-C₈-alkyl radical
R⁷ is a C₁-C₈-alkyl radical or C₁-C₈-heteroalkyl radical.

3. The process according to claim 1, wherein the introduction of the polyurethane system in step (B) is effected at one end of the pipe or in the middle of the pipe or at any point between one end and the middle of the pipe.

4. The process according to claim 1, wherein the at least one polyol mixture (b) comprises polyols (b1), optionally chemical blowing agents (b2), crosslinkers (b3), chain extenders (b4), additives (b5) and/or physical blowing agent (b6).

5. The process according to claim 4, wherein from 1 to 25% by weight of flame retardants, based on the total weight of the polyol mixture, is used as additive (b5).

6. The process according to claim 1, wherein the reaction of the isocyanate component (a) with the polyol mixture (b) is carried out at an index in the range from 90 to 240.

7. The process according to claim 1, wherein the reaction is carried out at a compaction of less than 4.0.

8. The process according to claim 1, wherein the polyurethane system is foamed using cyclopentane as physical blowing agent.

9. The process according to claim 1, wherein a folded spiral-seam tube is used as sheathing pipe.

10. The process according to claim 1, wherein a pipe based on a thermoplastic polymer is used as sheathing pipe.

11. The method of using a polyurethane system comprising an isocyanate component (a), a polyol mixture (b) and at least one catalyst for producing insulated pipes, wherein the cream time for the polyurethane system is less than the time for introduction of the polyurethane system into the pipe.

12. The method according to claim 11, wherein an amine of the general formula (I)
R¹R²N(CR³R⁴)ₙ—X (I),
where R¹, R², R³, R⁴, n and X have the following meanings:
R¹, R² are each, independently of one another, a C₁-C₈-alkyl radical,
R³, R⁴ are each, independently of one another, hydrogen or a C₁-C₈-alkyl radical,
n is an integer from 1 to 6 and
X is OR⁵ or NR⁶R⁷ where
R⁵ is a C₁-C₈-alkyl radical or C₁-C₈-heteroalkyl radical,
R⁶ is, independently of one another, hydrogen or a C₁-C₈-alkyl radical
R⁷ is a C₁-C₈-alkyl radical or C₁-C₈-heteroalkyl radical,
is used as catalyst.

13. The method of using an amine of the general formula (I)
R¹R²N(CR³R⁴)ₙ—X (I),
where R¹, R², R³, R⁴, n and X have the following meanings:
R¹, R² are each, independently of one another, a C₁-C₈-alkyl radical,
R³, R⁴ are each, independently of one another, hydrogen or a C₁-C₈-alkyl radical,
n is an integer from 1 to 6 and
X is OR⁵ or NR⁶RT where
R⁵ is a C₁-C₈-alkyl radical or C₁-C₈-heteroalkyl radical,
R⁶ is, independently of one another, hydrogen or a C₁-C₈-alkyl radical,
R⁷ is a C₁-C₈-alkyl radical or C₁-C₈-heteroalkyl radical,
as catalyst in a polyurethane system for producing insulated pipes.

14. An insulated pipe which can be obtained by a process according to claim 1.
